(19) United States
(12) Patent Application Publication
(10) Pub. No.: US 2023/0346189 A1
(43) Pub. Date: Nov. 2, 2023

(54) OBSTACLE AVIODANCE MECHANISM AND SWEEPING ROBOT

(71) Applicants: HONGFUJIN PRECISION ELECTRONS (YANTAI) CO., LTD., Yantai (CN); HON HAI PRECISION INDUSTRY CO., LTD., New Taipei (TW)

(72) Inventor: Teng-Yuan CHANG, New Taipei (TW)

(21) Appl. No.: 18/132,819

(22) Filed: Apr. 10, 2023

(30) Foreign Application Priority Data
Apr. 27, 2022 (CN) 202210454757.2

(51) Int. Cl. A47L 11/40; G05D 1/02

(52) U.S. Cl. CPC A47L 11/4061; A47L 11/4011; G05D 1/0231; A47L 2201/04; A47L 2201/06; G05D 2201/0203

(57) ABSTRACT

An obstacle avoidance mechanism applied to a sweeping robot, the sweeping robot comprises a body, a baffle and a road wheel, the baffle is arranged on an exterior side of the body, the baffle is arranged at a first distance from the body, the obstacle avoidance mechanism comprises a shield module and a photosensitive module. When the baffle collides with the an obstacle object, the light path of the photosensitive module is blocked by the shield module, so as to send out a first signal to make the road wheel stop moving forward or turn, and realize the obstacle avoidance function of the sweeping robot and enhance its service life.

### TECHNICAL FIELD

The subject matter herein generally relates to movable machinery equipment.

### BACKGROUND

Due to the complex surrounding environment, a sweeping robot often bumps into walls, tables, chairs and other obstacles in the process of working. Frequent impacts will cause different degrees of damage to the sweeping robot, which will reduce the safety performance of the sweeping robot and shorten the service life of the sweeping robot.

### BRIEF DESCRIPTION OF THE DRAWINGS

Implementations of the present technology will now be described, by way of example only, with reference to the attached figures.

FIG. 1 is an exploded diagram of an obstacle avoidance mechanism in one embodiment of the present application.

FIG. 2 is an exploded diagram of a sweeping robot according to an embodiment of the present disclosure.

FIG. 3 is a stereoscopic diagram of the obstacle avoidance mechanism shown in FIG. 1.

FIG. 4 is a partial decomposition diagram of the obstacle avoidance mechanism shown in FIG. 1.

FIG. 5 is another partial decomposition diagram of the obstacle avoidance mechanism shown in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

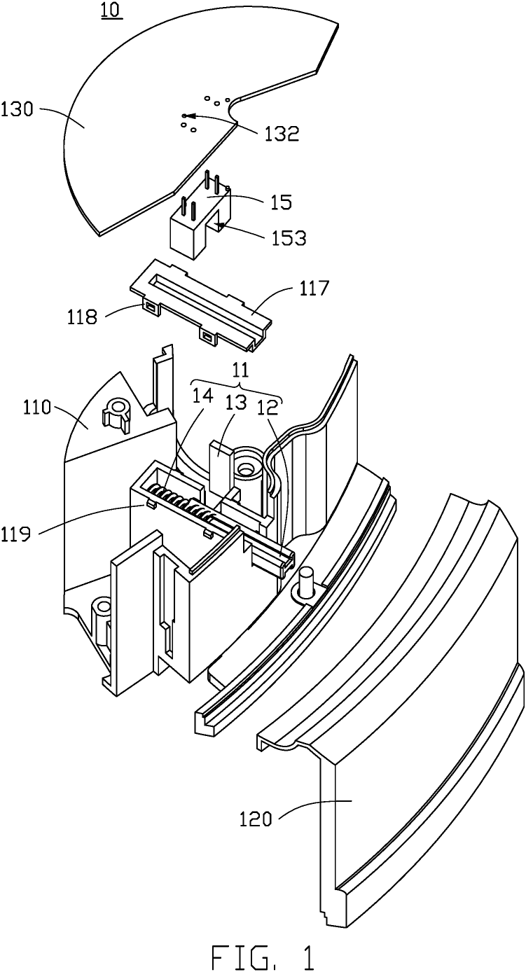

FIG. 1 is an exploded diagram of an obstacle avoidance mechanism 10 in one embodiment of the present application. The obstacle avoidance mechanism 10 can be set in a sweeping robot 100 and configured to realize the obstacle avoidance function of the sweeping robot 100, and a service life of the sweeping robot 100 can be enhanced.

The sweeping robot 100 comprises a body 110 and a baffle 120, the baffle 120 is arranged an exterior side of the body 110, the baffle 120 is arranged at a first distance from the body 110. The obstacle avoidance mechanism 10 comprises a shield module 11 and a photosensitive module 15. The shield module 11 comprises a sliding block 12, a shading element 13, and an elastic element 14, the sliding block 12 is arranged between the body 110 and the baffle 120, the sliding block 12 and the baffle 120 can be separated or touched, the sliding block 12 is connected to the body 110 through the elastic element 14, the sliding block 12 is fixed with the shading element 13 and configured to drive the shading element 13 to move. The photosensitive module 15 is arranged on the body 110, the photosensitive module 15 is configured to form a light path X, the shading element 13 is moveable to match with the photosensitive module 15 and block or unblock the light path X.

In one embodiment, when the baffle 120 collides with an obstacle object, the baffle 120 is contact with the sliding block 12 and pushes the sliding block 12 to move in the first direction to become closer to the body 110, the elastic element 14 is compressed by the sliding block 12, the sliding block 12 drives the shading element 13 to become closer to the photosensitive module 15 to block the light path X, the photosensitive module 15 sends a first signal according to the light path X being blocked, the sweeping robot 100 further comprises a road wheel 60, the first signal is configured to stop or turn the road wheel 60.

In one embodiment, when the sweeping robot 100 leaves the obstacle object, the baffle 110 restores the original position, the elastic element 13 is released, the elastic element 13 in a state of compression drives the sliding block 12 to restore the original position under a compression force, the sliding block 12 drives the shading element 13 away from the photosensitive module 15, so that the optical path X is restored to be unblocked.

The obstacle avoidance mechanism 10 realizes the obstacle avoidance function by the shield module 11 and the photosensitive module 15 cooperating with each other. When the baffle 120 collides with the obstacle object, under the impact of external force, the shading element 13 blocks the optical path X. At the same time, the elastic element 14 is compressed by the sliding block 12, and the photosensitive module 15 feeds back the first signals according to the situation that the optical path X is blocked, so that the road wheel 60 stops moving forward or turn, thus realizing the obstacle avoidance function. When the sweeping robot 100 leaves the obstacle object, the baffler 120 restores its original position. The elastic element 14 in the compression state drives the sliding block 12 to restore the original position under the compression force. The sliding block 12 drives the shading element 13 away from the photosensitive module 15, so that the optical path X can be unblocked and the road wheel 60 can resume its working state.

The body 110 can be arranged as disc shape, the baffle 120 is arranged as circular arc, the baffle 120 is arranged on the front side of the body 110. When the sweeping robot 100 hits the wall or the obstacle objects, such as tables, chairs, or benches, the baffle 120 of circular arc can better match with the body 110, so that the road wheel is easier to walk or turn, enhancing the applicability of the sweeping robot 100 and reducing the damage of the sweeping robot 100.

In other embodiments, the sweeping robot 100 comprises a plurality of baffles 120 and a plurality of obstacle avoidance mechanisms 10. The plurality of baffles 120 and the plurality of obstacle avoidance mechanisms 10 are arranged on the outside of the sweeping robot 100, the obstacle avoidance mechanisms 10 are arranged in a circular equidistant manner. In the working process of sweeping robot 100, the plurality of baffles 120 and the plurality of obstacle avoidance mechanisms 10 can maximize the protection of the body 110, and better realize the obstacle avoidance function.

In one embodiment, the material of baffle 120 can be plastic. When the baffle 120 is impacted, plastic material has better expansibility and flexibility, and is not easy to be damaged. It can enhance the practicability of the obstacle avoidance mechanism 10.

In one embodiment, the outer surface of the baffle 120 can be wrapped with spongy cushion layer to enhance the protection performance of the obstacle avoidance mechanism 10, to prevent furniture and other objects from being damaged by impact, and enhance the service life of the sweeping robot 100.

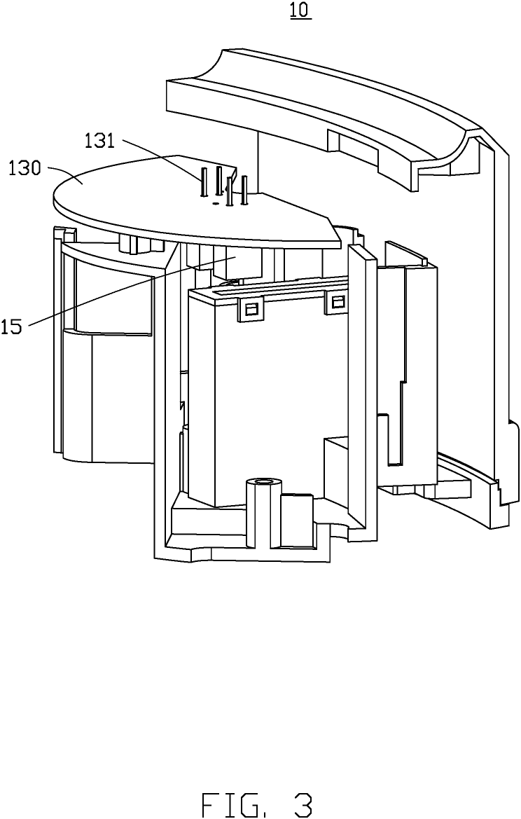

FIG. 3 is a stereoscopic diagram of the obstacle avoidance mechanism shown in FIG. 1.

The body comprises a mounting plate 130 arranged on the top of body 110. The photosensitive module 15 is fixed to the side of the mounting plate 130 close to the body 110. Specifically, the top of the photosensitive module 15 is extended with a plurality of fixing column 131. Correspondingly, the mounting plate 130 comprises a plurality of fixing holes 132, the fixing column 131 passes through the fixing hole 132, so that the photosensitive module 15 can be fixed on the mounting plate 130 to ensure the stability of the installation position of the photosensitive module 15. Thus, the photosensitive module 15 can better match with the shield module 11 to achieve the obstacle avoidance function.

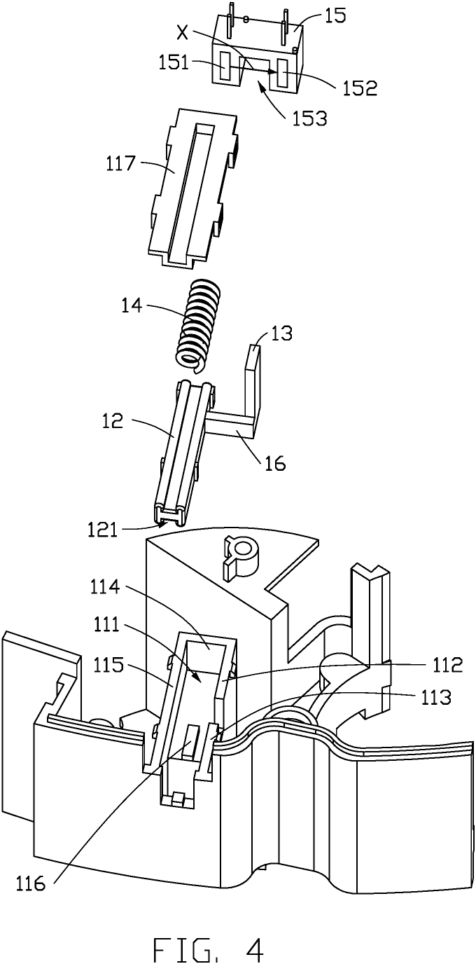

FIG. 4 is a partial decomposition diagram of the obstacle avoidance mechanism shown in FIG. 1.

The body 100 comprises a sliding groove 111, the sliding block 12 and the elastic element 14 are movably arranged in the sliding groove 111, the obstacle avoidance mechanism 10 further comprises a first side plate 112 and a second side plate 113, the first side plate 112 and the second side plate 113 are arranged on the side of the sliding block 12 which is closest to the shading element 12 along the extension direction of the sliding block 12, the sliding block 12 is fixedly connected with the shading element 13 through a connection shaft 16, the connecting shaft 16 is arranged at the interval between the first side plate 112 and the second side plate 113.

In this embodiment, in order to better realize the obstacle avoidance function, the elastic element 14 can be a tensile spring with strong elastic force. In other embodiments, the elastic element 14 can also be an elastic rubber material.

In this embodiment, a spacing distance between the first side plate 112 and the second side plate 113 can be set according to the actual production needs, which shall ensure the realization of the following situations: when the baffle 120 collides with the obstacle object, the baffle 120 pushes the sliding block 12 to move in the direction close to the body 110, and the sliding block 12 drives the connection shaft 16 and the shading element 13 to move in the direction close to the photosensitive module 15 until the connection shaft 16 touches the first side plate 112. The first side plate 112 limits the sliding block 12 by blocking the movement of the connection shaft 16, so that the shading element 13 moves exactly in the photosensitive module 15 to block the optical path X, and the photosensitive module 15 feeds back the first signal according to the situation that the optical path X is blocked, to stop or turn the road wheel. When the sweeping robot 100 leaves the obstacle object, the elastic element 14 in the compression state moves the sliding block 12 in the direction close to the baffle 120 under the compression force until the connecting shaft 16 touches the second side plate 113. The second side plate 113 limits the sliding block 12 by blocking the movement of connecting shaft 16 to ensure that the sliding block 12 restores to original position, preventing the sliding block 12 from hitting baffle 120 under the compression force of elastic element 14 and causing damage to the baffle 120.

In one embodiment, the obstacle avoidance mechanism 10 further comprises a third side plate 114, the third side plate 114 is arranged at the end of the slide groove 111 away from the baffle 120, the third side plate 114 is fixedly connected with the first side plate 112, a first end of the elastic element 14 can be separated from or in contact with the third side plate 114, a second end of the elastic element 14 can be separated from or in contact with the sliding block 12.

A fourth side plate 115 is arranged at the opposite side of the first side plate 112 (or the second side plate 113) with a third distance from the first side plate 112 (or the second side plate 113). The first side plate 112 and the fourth side plate 115 are respectively vertically connected to the third side plate 114. The first side plate 112, second side plate 113, third side plate 114 and fourth side plate 115 are enclosed to form a semi-closed sliding groove 111. Since the sliding block 12 and the elastic element 14 are movably arranged in the sliding groove 111, the semi-closed sliding slot 111 can limit the movement direction of the sliding block 12 and the elastic element 14 to prevent the sliding block 12 and the elastic element 14 from deviating from the moving direction during the moving process.

The sliding groove 111 comprises a navigation bar 116 along the extension direction of the sliding block 12, the sliding block 12 comprises a navigation track 121 at the bottom of the sliding block 12, the navigation bar 116 is arranged in the navigation track 121, the navigation bar 116 and the navigation track 121 cooperate to navigate the moving direction of the sliding block 12, to prevent deviation of moving stroke.

The obstacle avoidance mechanism further comprises a cover plate 117 arranged at the top of the sliding groove 111 and fixed with the sliding groove 111. The cover plate 117 comprises a plurality of buckles 118 respectively arranged at the two sides of the cover plate 117. Correspondingly, the outer sides of the first side plate 112, the second side plate 113 and the third side plate 114 are respectively arranged with a fixed block 119. The fixed block 119 is protruded in the buckle 118 to fix the cover plate 117 with the sliding groove 111 and prevent the sliding block 12 from falling off from the sliding groove 111 when the baffle plate 120 is subjected to a large impact force.

The sliding block 12 can be a rectangular structure, the sliding groove 111 is compatible with the sliding block 12, the sliding groove 111 can also be a rectangular structure. The length of the sliding groove 111 is slightly greater than the sum of length of the sliding block 12 and the elastic element 14, providing sufficient space for sliding block 12 and elastic element 14 to move.

In one embodiment, the photosensitive module 15 comprises an optical transmitting unit 151 and an optical receiving unit 152, the optical transmitting unit 151 is arranged at a second distance from the optical receiving unit 152, the light path X is transmitted from the optical transmitting unit 151 to the optical receiving unit 152, the shading element 13 is movably arranged between the optical transmitting unit 151 and the optical receiving unit 152, so that the light path X can be unblocked or blocked.

In one embodiment, the photosensitive module 15 comprises a light sensing window 153, the light transmitting unit 151 and the light receiving unit 152 are located on opposite sides of the light sensing window, when the shading element 13 is located in the light sensing window 153, the light path X is blocked, when the shading element 13 leaves the light sensing window 153, the optical path X is restored to be unblocked.

The photosensitive module 15 can be an optical blocker, also known as a penetrating photosensor. The penetrating photosensor is a photosensor that the luminous component and the light-receiving component are arranged face to face with each other in the same package. The detection function can be realized by using the principle of blocking light when detecting objects passing through. When the baffle 120 collides with external objects, the light shading element 13 moves to the light sensing window 153 and blocks the light path X in the photosensitive module 15. The photosensitive module 15 feeds back a first signals according to the situation that the light path X is blocked, to stop or turn the road wheel 60. When the baffle 120 leaves the obstacle object, the elastic element 14 in the compressed state pushes the sliding block 12 to move in the direction close to the baffle 120 under the action of restoring force, so that the shading element 13 leaves the light sensing window 153, and the optical path X is unblocked again, so that the road wheel 60 can restore to its working state.

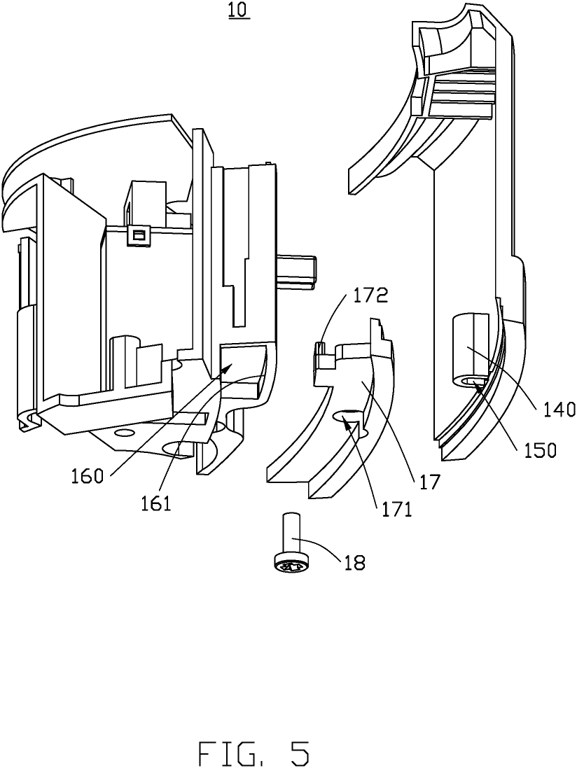

FIG. 5 is a partial decomposition diagram of the obstacle avoidance mechanism shown in FIG. 1.

The obstacle avoidance mechanism 10 also includes a bottom plate 17 and a connecting piece 18, the bottom plate 17 is movably arranged at the bottom of the body 110, the bottom plate 17 comprises a first through hole 171, the baffle 120 comprises a fixing part 140 arranged on the side of the baffle 120 close to the bottom plate 17, the fixing part 140 comprises a second through hole 150, the connecting piece 18 extends through the first through hole 171 and the second through hole 150, so that the bottom plate 17 is fixed to the baffle 120.

The connecting piece 18 can be a screw with external thread, the first through hole 171 and the second through hole 150 can be a screw hole with internal thread, the connecting piece 18 matches with the first through hole 171 and the second through hole 150 through the external thread and the internal thread, so that the baffle 120 and the bottom plate 17 are fixedly connected.

In one embodiment, the bottom plate 17 comprises a limited block 172 arranged on the side of the bottom plate 17 which is closest to the body 110, the body 110 comprises a groove 160 arranged on the side of the body 110 close to the bottom plate 17, the limit block 172 is movably arranged in the groove 160.

The limit block 172 has a certain activity space in the groove 160, so that the baffle 120 can drive the limit block 172 to move in the groove 160. When the baffle 120 collides with the obstacle object, the limit block 172 moves in the groove 160 under the push of the baffle 120 and can play a certain buffering role on the baffle 120, thus reducing the damage to the baffle 120 and enhancing the service life of the sweeping robot 100. The groove 160 comprises a side wall 161. When the baffle 120 is reset, the limit block 172 touches the side wall 161 to prevent the baffle 120 from being separated from the body 110 and losing the protective effect on the body 110.

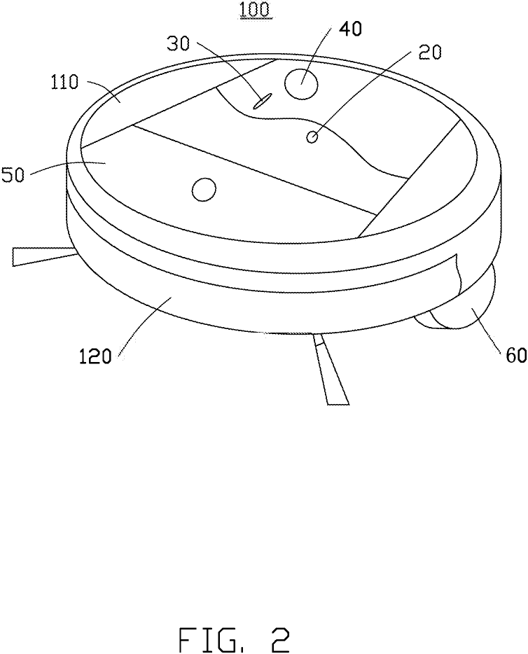

FIG. 2 is an exploded diagram of the sweeping robot 100.

The sweeping robot 100 comprises the obstacle avoidance mechanism 10, a controller 20 and the road wheel 60. The controller 20 is electrically connected with the photosensitive module 15 of the obstacle avoidance mechanism 10, the controller 20 is configured to output a control signal in response to the feedback signal from the photosensitive module 15 to control the road wheel 60 to stop moving forward or turn.

In one embodiment, the sweeping robot 100 further comprises a dust sensor 30 and a dust suction device 40, the dust sensor 30 and the dust suction device 40 are electrically connected with the controller 20, the dust sensor 30 is configured to detect the dust concentration in the environment and convert the dust concentration into a second signal feeding back to the controller 20, the controller is configured to control the dust suction device 40 to clean the dust in the environment according to the second signal.

The body 110 comprises a control panel 50 arranged at the top of the body 110. The control panel 50 is configured to display the working state of the sweeping robot 100. The control panel 50 is also convenient for users to operate and control the sweeping robot 100 and improves the aesthetics of the sweeping robot 100.

When the baffle 120 collides with an obstacle object during the working process of the sweeping robot 100, the baffle 120 shrinks in the direction close to the body 110. The baffle 120 touches the sliding block 12 and pushes the sliding block 12 to move along the navigation bar 116 in the direction close to the third side plate 114 until the connecting shaft 16 touches the first side plate 112. At this time, the sliding block 12 drives the shading element 13 to move exactly to the optical sensing window 153 of the photosensitive module 15, so that the optical path X in the photosensitive module 15 is blocked. The elastic element 14 is compressed by the sliding block 12. The photosensitive module 15 feeds back a first signals to the controller 20 according to the situation that the optical path X is blocked, and the controller 20 controls the road wheel to stop moving forward or turn according to the first signal of the photosensitive module 15, thus realizing the obstacle avoidance function of the sweeping robot 100.

When the sweeping robot 100 leaves the obstacle object, the baffle 120 is reset. At the same time, the elastic element 14 in the compressed state restores to initial state under the action of restoring force, and pushes the sliding block 12 to move away from the third side plate 114 along the navigation bar 116 until the connecting shaft 16 touches the second side plate 113. The sliding block 12 drives the shading element 13 away from the light sensing window 153 of the photosensitive module 15, so that the optical path X in the photosensitive module 15 can be unblocked and the sweeping robot 100 can be restored to normal working state.

The obstacle avoidance mechanism 10 and the sweeping robot 100 provided in the present application can realize obstacle avoidance. When the baffle 120 collides with an obstacle object, the optical path X of the photosensitive module 15 is blocked by the shading element 13 to send out a first signal to make the road wheel 60 stop moving forward or turn, thus realizing the obstacle avoidance function and improving the safety of sweeping robot 100 and enhancing the service life of sweeping robot 100.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. An obstacle avoidance mechanism applied to a sweeping robot, wherein the sweeping robot comprises a body and a baffle, the baffle is arranged on an exterior side of the body, the baffle is arranged at a first distance from the body, the obstacle avoidance mechanism comprises:
a shield module comprising a sliding block, a shading element, and an elastic element, wherein the sliding block is configured to be inserted between the body and the baffle, the sliding block is separated from or in contact with the baffle, the sliding block is connected to the body through the elastic element, the sliding block is fixed with the shading element, the sliding block is configured to drive the shading element to move; and
a photosensitive module configure to be arranged on the body, and form a light path, wherein the shading element is moveable to match with the photosensitive module, and the shading element is configured to block or unblock the light path.

2. The obstacle avoidance mechanism of claim 1,
wherein when the sliding block is pushed by the baffle to move in a first direction close to the body, the elastic element is compressed by the sliding block, the sliding block drives the shading element to become closer to the photosensitive module, and the light path is blocked by the shading element,
wherein when the light path is blocked by the shading element, the photosensitive module sends a first signal, the first signal is configured to control road wheels of the sweeping robot to stop or turn, and
wherein when the elastic element is released, the sliding block is pushed back to an original position by the elastic element, the sliding block drives the shading element away from the photosensitive module, and the optical path is unblocked by the shading element.

3. The obstacle avoidance mechanism of claim 1, wherein the sliding block and the elastic element are configured to be movably arranged in a sliding groove of the body of the sweeping robot, the obstacle avoidance mechanism further comprises a first side plate and a second side plate, the first side plate and the second side plate are arranged on a side of the sliding block which is closest to the shading element, the first and the second side plates are arranged along an extension direction of the sliding block, the sliding block is fixedly connected with the shading element through a connection shaft, the connecting shaft is arranged between the first side plate and the second side plate.

4. The obstacle avoidance mechanism of claim 3, wherein the obstacle avoidance mechanism further comprises a third side plate, the third side plate is configured to be arranged at an end of the slide groove away from the baffle, the third side plate is fixedly connected with the first side plate, a first end of the elastic element are separable from or in contact with the third side plate, a second end of the elastic element are separable from or in contact with the sliding block.

5. The obstacle avoidance mechanism of claim 1, wherein the photosensitive module comprises an optical transmitting unit and an optical receiving unit, the optical transmitting unit is arranged at a second distance from the optical receiving unit, the light path is defined from the optical transmitting unit to the optical receiving unit, the shading element is movably arranged between the optical transmitting unit and the optical receiving unit to block or unblock the light path.

6. The obstacle avoidance mechanism of claim 5, wherein the photosensitive module comprises a light sensing window, the light transmitting unit and the light receiving unit are located on opposite sides of the light sensing window, when the shading element is located in the light sensing window, the light path is blocked, and when the shading element is outside of the light sensing window, the optical path is unblocked.

7. The obstacle avoidance mechanism of claim 1, wherein the obstacle avoidance mechanism further comprises a bottom plate and a connecting piece, the bottom plate is configured to be movably arranged at a bottom of the body of the sweeping robot, the bottom plate comprises a first through hole, the connecting piece extends through the first through hole and a second through hole of the baffle to fix the bottom plate on the baffle.

8. The obstacle avoidance mechanism of claim 7, wherein the bottom plate further comprises a limited block arranged on a side of the bottom plate which is closest to the body, the limit block is configured to be movably arranged in a groove on a side of the body of the sweeping robot.

9. A sweeping robot comprising an obstacle avoidance mechanism, a controller, and a road wheel, wherein the controller is electrically connected with a photosensitive module of the obstacle avoidance mechanism, the controller is configured to output a control signal in response to a feedback signal from the photosensitive module to control the road wheel to stop moving or turn, the obstacle avoidance mechanism comprises:
a shield module comprising a sliding block, a shading element, and an elastic element, wherein the sliding block is configured to be inserted between the body and the baffle, the sliding block is separated from or in contact with the baffle, the sliding block is connected to the body through the elastic element, the sliding block is fixed with the shading element, the sliding block is configured to drive the shading element to move;
the photosensitive module configure to be arranged on the body, and form a light path, wherein the shading element is moveable to match with the photosensitive module, and the shading element is configured to block or unblock the light path.

10. The sweeping robot of claim 9, wherein the sweeping robot further comprises a dust sensor and a dust suction device, the dust sensor and the dust suction device are electrically connected with the controller, the dust sensor is configured to detect the dust concentration in the environment and convert the dust concentration into a second signal feeding back to the controller, the controller is configured to control the dust suction device to clean the dust in the environment according to the second signal.

11. The obstacle avoidance mechanism of claim 9,
wherein when the sliding block is pushed by the baffle to move in a first direction close to the body, the elastic element is compressed by the sliding block, the sliding block drives the shading element to become closer to the photosensitive module, and the light path is blocked by the shading element,
wherein when the light path is blocked by the shading element, the photosensitive module sends a first signal, the first signal is configured to control road wheels of the sweeping robot to stop or turn, and
wherein when the elastic element is released, the sliding block is pushed back to an original position by the elastic element, the sliding block drives the shading element away from the photosensitive module, and the optical path is unblocked by the shading element.

12. The sweeping robot of claim 9, wherein the sliding block and the elastic element are configured to be movably arranged in a sliding groove of the body of the sweeping robot, the obstacle avoidance mechanism further comprises a first side plate and a second side plate, the first side plate and the second side plate are arranged on a side of the sliding block which is closest to the shading element, the first and the second side plates are arranged along an extension direction of the sliding block, the sliding block is fixedly connected with the shading element through a connection shaft, the connecting shaft is arranged between the first side plate and the second side plate.

13. The sweeping robot of claim 12, wherein the obstacle avoidance mechanism further comprises a third side plate, the third side plate is configured to be arranged at an end of the slide groove away from the baffle, the third side plate is fixedly connected with the first side plate, a first end of the elastic element are separable from or in contact with the third side plate, a second end of the elastic element are separable from or in contact with the sliding block.

14. The sweeping robot of claim 9, wherein the photosensitive module comprises an optical transmitting unit and an optical receiving unit, the optical transmitting unit is arranged at a second distance from the optical receiving unit, the light path is defined from the optical transmitting unit to the optical receiving unit, the shading element is movably arranged between the optical transmitting unit and the optical receiving unit to block or unblock the light path.

15. The sweeping robot of claim 14, wherein the photosensitive module comprises a light sensing window, the light transmitting unit and the light receiving unit are located on opposite sides of the light sensing window, when the shading element is located in the light sensing window, the light path is blocked, and when the shading element is outside of the light sensing window, the optical path is unblocked.

16. The sweeping robot of claim 9, wherein the obstacle avoidance mechanism further comprises a bottom plate and a connecting piece, the bottom plate is configured to be movably arranged at a bottom of the body of the sweeping robot, the bottom plate comprises a first through hole, the connecting piece extends through the first through hole and a second through hole of the baffle to fix the bottom plate on the baffle.

17. The sweeping robot of claim 16, wherein the bottom plate further comprises a limited block arranged on a side of the bottom plate which is closest to the body, the limit block is configured to be movably arranged in a groove on a side of the body of the sweeping robot.
